(19) United States
(12) Patent Application Publication
(10) Pub. No.: US 2026/0172374 A1
(43) Pub. Date: Jun. 18, 2026

(54) CONTROL METHOD OF ROBOT, APPARATUS, ELECTRONIC DEVICE, STORAGE MEDIA, AND PRODUCT

(71) Applicant: Beijing Zitiao Network Technology Co., Ltd., Haidian District, Beijing (CN)

(72) Inventors: Jiawei LIU, Beijing (CN); Shixing JIN, Beijing (CN)

(21) Appl. No.: 19/117,484

(22) PCT Filed: Mar. 26, 2024
(86) PCT No.: PCT/CN2024/083780

§ 371 Date: Apr. 1, 2025

(51) Int. Cl. H04L 51/02; G06F 16/3329

(52) U.S. Cl. CPC H04L 51/02; G06F 16/33295

(57) ABSTRACT

A control method of robot relates to the field of artificial intelligence technology. The control method of robot includes: obtaining, in response to an input of a user, conversation messages among multiple robots with respect to the input of the user, wherein the multiple robots have an adversarial relationship to each other; performing conflict detection on the conversation messages among the multiple robots to determine conversation messages with a conflict and a conflict type; sending an adjustment instruction to at least one robot involved in the conflict, to enable each adjusted robot to continuously converse with other robots based on the adjustment instruction, wherein the adjustment instruction is generated based on the input of the user and the conflict type; and displaying, in response to the conversation messages among the multiple robots comprising a response to the input of the user without a conflict, the response.

### CROSS-REFERENCE TO RELATED APPLICATIONS

The present disclosure is a U.S. National Stage Application under 35 U.S.C. § 371 of International Patent Application No. PCT/CN2024/083780, filed on Mar. 26, 2024, the disclosure of which is hereby incorporated into this disclosure by reference in its entirety.

### TECHNICAL FIELD

This disclosure relates to the field of artificial intelligence technology, particularly to a control method of robot, an apparatus, an electronic device, a storage medium, and a product.

### BACKGROUND

Robots driven by artificial intelligence (AI) technology can provide feedback based on the received information. For example, in conversation scenarios, robots can generate their own conversation messages based on the conversation messages among other speakers. Robots often rely on machine learning models to generate responses. These machine learning models can be trained based on domain-specific data to enable robots to respond by taking into account the characteristics of specific domains, or the machine learning models can refer to the setting information of the robots when processing conversation messages from other speakers to generate conversation messages that can meet that setting information.

### SUMMARY

This summary is provided for a concise introduction of the inventive concept of the present application, which will be described in detail in the Detailed Description below. This summary is not intended to identify critical features or essential features of the claimed technical solution, nor is it intended to be used to limit the scope of the claimed technical solution.

According to some embodiments of the present disclosure, there is provided a control method of robot, including: obtaining, in response to an input of a user, conversation messages among multiple robots with respect to the input of the user, wherein the multiple robots have an adversarial relationship to each other; performing conflict detection on the conversation messages among the multiple robots to determine conversation messages with a conflict and a conflict type; sending an adjustment instruction to at least one robot involved in the conflict, to enable each adjusted robot to continuously converse with other robots based on the adjustment instruction, wherein the adjustment instruction is generated based on the input of the user and the conflict type; and displaying, in response to the conversation messages among the multiple robots comprising a response to the input of the user without a conflict, the response.

According to other embodiments of the present disclosure, there is provided a control apparatus of robot, including: an obtaining module configured for obtaining, in response to an input of a user, conversation messages among multiple robots with respect to the input of the user, wherein the multiple robots have an adversarial relationship to each other; a detection module configured for performing conflict detection on the conversation messages among the multiple robots to determine conversation messages with a conflict and a conflict type; a sending module configured for sending an adjustment instruction to at least one robot involved in the conflict, to enable each adjusted robot to continuously converse with other robots based on the adjustment instruction, wherein the adjustment instruction is generated based on the input of the user and the conflict type; and a display module configured for displaying, in response to the conversation messages among the multiple robots comprising a response to the input of the user without a conflict, the response.

According to some embodiments of the present disclosure, there is provided an electronic device, including: a memory; and a processor coupled to the memory, the processor configured to perform the control method of robot according to any embodiment of the present disclosure based on the instructions stored in the memory.

According to some embodiments of the present disclosure, there is provided a non-transitory computer readable storage medium having stored thereon a computer program that, when executed by a processor, performs the control method of robot provided by any embodiment of the present disclosure.

According to some embodiments of the present disclosure, there is provided a non-transitory computer program product that, when executed on a computer, causes the computer to implement the control method of robot provided by any embodiment of the present disclosure.

According to some embodiments of the present disclosure, there is provided a computer program, including: instructions that, when executed by a processor, cause the processor to perform the control method of robot provided by any embodiment of the present disclosure.

Other features, aspects and advantages of the present disclosure will become apparent from the following detailed description of exemplary embodiments of the present disclosure with reference to the accompanying drawings.

### BRIEF DESCRIPTION OF THE DRAWINGS

Below, preferred embodiments of this disclosure will be described with reference to the drawings. The accompanying drawings described herein are intended to provide a further understanding of the present disclosure, and together with the specific description of the drawings below, are included in and constitute a part of the present specification for illustration of the present disclosure. It should be understood that the drawings described below merely involve some embodiments of the present disclosure, and are not limitations of the present disclosure. In the drawings:

FIG. 1 shows a flowchart of a control method of robot according to some embodiments of the present disclosure;

FIG. 2 shows a flowchart of a conflict detection method according to some embodiments of the present disclosure;

FIG. 3 shows a flowchart of a conflict detection method according to other embodiments of the present disclosure;

FIG. 4 shows a flowchart of a method for generating an adjustment instruction according to some embodiments of the present disclosure;

FIG. 5A shows a schematic diagram of a user interface according to some embodiments of the present disclosure;

FIG. 5B shows a schematic diagram of a user interface according to other embodiments of the present disclosure;

FIG. 5C shows a schematic diagram of a user interface according to still other embodiments of the present disclosure;

FIG. 6 shows a schematic structural diagram of a control apparatus of robot according to some embodiments of the present disclosure;

FIG. 7 shows a schematic structural diagram of an electronic device according to some embodiments of the present disclosure;

FIG. 8 shows a schematic structural diagram of a computer system according to some embodiments of the present disclosure.

It should be understood that, for ease of description, the dimensions of the various parts shown in the drawings are not drawn to actual proportions. Throughout the drawings, the same or similar reference signs indicate the same or similar elements. Therefore, once an item is defined in a drawing, there is no need for further discussion in other accompanying drawings.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The description of the embodiments is merely illustrative, and in no way serves as any limitation on the present disclosure and its application or use. It should be understood that the present disclosure can be implemented in various forms and should not be construed as limited to the embodiments set forth herein.

It should be understood that the various steps described in the methods of the embodiments of the present disclosure may be executed in a different order, and/or executed in parallel. In addition, the methods may include additional steps and/or some of the illustrated steps may be omitted. The scope of this disclosure is not limited in this regard. Unless specifically stated otherwise, relative arrangement and values of components and steps, numerical expressions and values set forth in these embodiments are to be construed as merely illustrative, not limiting the scope of the present disclosure.

The term “comprising” and its variations used in this disclosure refer to an open-ended term that includes at least the following elements/features, but does not exclude other elements/features, i.e. “comprising but not limited to”. In addition, the term “including” and its variations used in this disclosure refer to an open-ended term that includes at least the following elements/features, but does not exclude other elements/features, i.e., “including but not limited to”. Therefore, the terms “comprising” and “including” are synonymous. The term “based on” means “based at least in part on”.

“An embodiment”, “some embodiments” or “embodiments” used throughout the specification mean that specific features, structures or characteristics described in connection with the embodiments are included in at least one embodiment of the present invention. For example, the term “an embodiment” means “at least one embodiment”; the term “another embodiment” means “at least one additional embodiment”; the term “some embodiments” means “at least some embodiments”. In addition, occurrences of the phrases “in an embodiment,” “in some embodiments,” or “in embodiments” throughout this specification do not necessarily refer to the same embodiment, but may refer to the same embodiment.

It should be noted that the concepts of “first” and “second” mentioned in the present disclosure are only used to distinguish different devices, modules or units, and are not used to limit the order of functions performed by these devices, modules or units, or interdependence therebetween. Unless otherwise specified, terms such as “first” and “second” are not intended to imply that objects described in this way must be in any particular order in time, space, rank, or otherwise.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

The following will provide a detailed explanation of the embodiments disclosed herein with reference to the accompanying drawings, but the present disclosure is not limited to these specific embodiments. The following specific embodiments can be combined with each other, and the same or similar concepts or processes may not be repeated in some embodiments. In addition, in one or more embodiments, specific features, structures or characteristics may be combined in any suitable manner, as will be apparent to those skilled in the art from this disclosure.

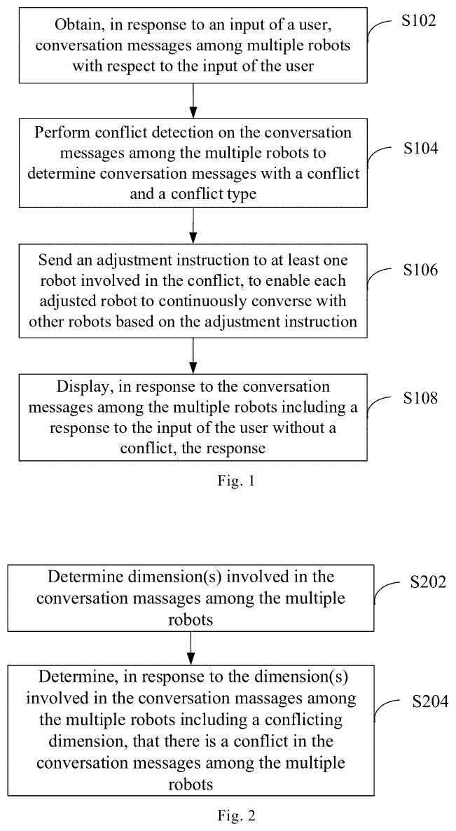

Because of the ability of robots to generate conversation messages based on input information, users can obtain information by conversing with robots. For example, robots can serve as search tools to provide users with search results, or as advisory tools to provide users with solutions to a particular task. However, the content provided by a robot may have limitations, resulting in inaccurate responses to users and reducing their information acquisition efficiency. Therefore, this disclosure utilizes multiple adversarial robots to jointly respond to the input of the user, so that the response can take into account the dimensions referred to by the multiple robots. An embodiment of the control method of robot provided by the present disclosure will be described below with reference to FIG. 1.

FIG. 1 shows a flowchart of a control method of robot according to some embodiments of the present disclosure. As shown in FIG. 1, the control method of this embodiment includes steps S102 to S108.

In step 102, in response to an input of a user, conversation messages among multiple robots with respect to the input of the user are obtained, wherein the multiple robots have an adversarial relationship to each other.

A user can provide input on a user device, for example, through an input interface provided by an application on the user device. The input of the user can be a task proposed by the user to the robots, which can be represented by at least one of text, audio, image, or video. The input of the user involves multiple dimensions, which can be either its semantics or the procedures used to process the input. Taking semantics as an example, the literal meaning of the input of the user may include multiple dimensions, or multiple dimensions can be determined through association search and analysis of a topic involved in the input of the user. For example, if the input of the user is “Please recommend me a mobile phone with good performance and affordable price”, two dimensions, namely performance and price dimensions, can be determined from its literal meaning. As another example, if the input of the user is “Please recommend me a mobile phone”, by analyzing its semantics, the topic is “phone recommendation”. By searching and analyzing information related to phone recommendation, it can be concluded that the topic of “phone recommendation” may involve multiple dimensions such as performance, price, and appearance.

The robot in this embodiment refers to an agent capable of generating responses to input information, which can be implemented in software, hardware, or a combination of software and hardware. Robots can also be referred to as digital humans or virtual agents of machine learning models. Robots can be implemented based on machine learning models, such as Large Language Models (LLM) or Foundation Models. Machine learning models can be generative models, which are used to output target content based on input information. The input information of a generative model includes the processing basis of the generative model during the generation process, such as what information is referenced to conduct the generation process, the requirements of the output target content, and so on. Generative models include models that generate based on text or images, and their output can be text, images or a combination of text and images. Of course, the input or output of generative models can also be data from other modalities, such as audio, video, or a combination of multiple types of data. Generative models may be single-modal models, such as the models that generate text based on text (referred to as “text to text-generation model”), or models that generate images based on images (referred to as “image to image generation model”); or generative models may also be cross-modality models, the input and output of which belong to different modalities, such as models that generate images based on text (referred to as “text to image generation models”); or the input and output of generative models may be data from multiple modalities.

For example, after receiving input information, a robot processes the input information as needed and then inputs it into a machine learning model; the robot then obtains the output of the machine learning model and processes it as needed to generate the robot's output. The output of the robot can be directly displayed on an interface of the user device, or transmitted to other modules in the user device (such as other robots or virtual objects) for further processing.

The adversarial relationship of the multiple robots is reflected in their ability to generate response content based on adversarial setting information. For example, the multiple robots are based on different machine learning models trained on adversarial training data. Alternatively, when the multiple robots process the input information, the input information also includes adversarial setting information. For example, in the scenario of recommending mobile phones to a user, one robot may prioritize performance for recommendations, while another robot may prioritize price for recommendations.

After receiving input of the user, each robot can first process the input of the user and generate a message from the robot (i.e., a conversation message), or each robot can also process the input of the user and replies generated by other robots to generate its own reply. Each robot's reply can be visible to the user or can be transmitted only between robots. That is, the “chats” between the robots can be visually presented to show the user the game process between the robots. It is also possible to hide the conversation process among the robots and only present the final response result to the user after the robots have reached a consensus.

In step 104, conflict detection is performed on the conversation messages among the multiple robots to determine conversation messages with a conflict and a conflict type.

Due to the adversarial relationship of the multiple robots, there may be the conflict in the conversation messages among the robots. If the conflict remains unresolved, the robots may even reach an impasse, resulting in no substantive progress in the conversation. As a result, the user is unable to obtain timely and effective responses to his/her input.

When performing conflict detection, key information can be extracted by performing semantic analysis on the conversation messages among the robots. This key information can reflect the key content in one or more messages of a robot, or is a summary of the conversation messages among the multiple robots. It is also possible to form a key information sequence from a plurality of pieces of key information extracted. Then, the key information/key information sequence is matched with preset conflict detection information to identify whether there is a conflict. Alternatively, the conversation messages among the robots can be directly matched with the conflict detection information to identify the presence of a conflict. Those skilled in the art can also use other conflict detection methods as needed, which will not be described in detail here.

In some embodiments, a conflict controller can be used to monitor robot conversations. For example, prompt information (Prompt) for conflict detection is input into the controller to indicate the conflict controller to recognize conversation messages with the conflict and the conflict type. The prompt information can include conflict detection information. The conflict detection information includes, for example, negative conversation examples and their corresponding conflict types, wherein the negative conversation examples are examples of conversation messages with the conflict.

In step 106, an adjustment instruction is sent to at least one robot involved in the conflict, to enable each adjusted robot to continuously converse with other robots based on the adjustment instruction, wherein the adjustment instruction is generated based on the input of the user and the conflict type.

The adjustment instruction is used to notify a robot to adjust its message generation method, generated content, or other generated information. The robot can adjust its setting information accordingly, or can apply the adjustment instruction as a temporary extension on the basis of its setting information. The robot can process the adjustment instruction to update its conversation strategy. For example, the adjustment instruction or content determined based on the adjustment instruction is input into a machine learning model to obtain content output from the machine learning model.

When a conflict occurs, all or some of the robots involved in the conversation messages with the conflict can be identified as the robots to be adjusted. That is, all robots involved in the conflict can be adjusted, or some robots involved in the conflict can be adjusted. For example, some robots or all robots can be instructed to make a compromise. In some embodiments, a dimension involved in the conflict type can be determined and a robot can be instructed to make an opposite adjustment in that dimension. For example, if robots are in conflict and are deadlocked on price, a robot that insists on low prices can be instructed to raise the price floor.

In some embodiments, the adjustment instruction also includes conversation messages with the conflict. This helps the robots make more accurate adjustments by more clearly indicating which conversations run into problems. However, since each robot can receive messages sent from other robots and store its own messages, it is also possible to avoid sending conversation messages with the conflict to the robots separately.

In step S108, in response to the conversation messages among the multiple robots including a response to the input of the user without a conflict, the response is displayed.

The robots may make multiple rounds of conversation based on the input of the user, and the first round of conversation may not be fully responsive to the input of the user. For example, for the task of recommending a mobile phone inputted by the user, the multiple robots can first predetermine candidate models and then make a selection through discussion. Semantic analysis can be used to determine whether the robots'conversation messages include a response to the input of the user, i.e., whether the robots have completed communication and discussion in response to the input of the user.

If the robots'conversation messages include a response to the input of the user, whether a conflict exists can be determined according to the above conflict detection method. If there is no conflict, it indicates that the robots have reached an agreement and that the response of the robots can be displayed to the user.

The above embodiment uses multiple adversarial robots to jointly derive a response to the input of the user, so that the response can be considered from multiple dimensions and has higher reliability. Due to the adversarial relationship between the robots, a conflict may arise during the conversation process. In response to a conflict or even a deadlock in the conversation, an adjustment instruction is sent to at least one of the robots involved in the conflict to allow the conversation to continue between the robots and improve the efficiency of the response to the user.

In some embodiments, the input of the user involves multiple dimensions, and each of the multiple robots is configured to generate conversation messages based on some or all of the multiple dimensions. Different robots may have some overlapping dimensions, but the dimensions of different robots are not exactly the same, resulting in adversarial behavior among the robots. For example, the dimensions of robot A may include high performance and beautiful appearance, while the dimensions of robot B may include low price and beautiful appearance. They both have the “beautiful appearance” dimension, but they are opponents in terms of performance and price.

In the process of conflict detection, detection can be performed based on the dimensions involved in the conversation among the robots. An embodiment of the conflict detection method provided in this disclosure will be described with reference to FIG. 2.

FIG. 2 shows a flowchart of a conflict detection method according to some embodiments of the present disclosure. As shown in FIG. 2, the conflict detection method of this embodiment includes steps S202 to S204.

In step S202, dimension(s) involved in the conversation massages among the multiple robots are determined. For example, semantic analysis can be performed on the conversation messages among the robots to determine key information of the conversation massages and match it with multiple dimensions involved in the input of the user to determine the dimension(s) involved in the conversation.

Due to the adversarial relationship among the robots, a message sent from one robot may have conflicting dimension(s) with a message sent from another robot. However, some robots can make adjustments on their own during multiple rounds of interaction. Therefore, in some embodiments, based on the multiple rounds of conversation messages among the robots, an overall dimension analysis can be performed for each robot. For example, if a robot insists on a low price at the beginning of a conversation, but compromises on the price during multiple rounds of interaction, then the robot's conversation does not involve a Low Price dimension.

In some embodiments, based on the conversation messages among the multiple robots, at least one of a topic of the conversation messages, a flow of the conversation messages, or an interaction pattern of the multiple robots are determined; and dimensions involved in at least one of the topic of the conversation messages, the flow of the conversation messages or the interaction pattern of the multiple robots are determined as the dimension(s) involved in the conversation messages among the multiple robots. For example, semantic analysis can be performed on the robot conversation messages to obtain at least one of the topic of the conversation messages, the flow of the conversation messages, or the interaction pattern of the multiple robots, and match them with preset templates of dimensions involved in the topic of the conversation messages, the flow of the conversation messages, and the interaction patterns of the multiple robots to determine the dimension(s) involved in the conversation.

The topic of the conversation messages refers to the core content of the conversation, as determined by the analysis of the conversation content. The flow of the conversation messages refers to the flow of analysis and processing of the input of the user. For example, when recommending a mobile phone to a user, a lot of candidate mobile phone models can be determined first, and then a selection can be made from the candidate mobile phone models. Alternatively, each robot can first recommend one model, and a more suitable model can be found based on multiple rounds of conversation among the robots. The interaction pattern refers to whether the robots are divided to perform different tasks, grouped to perform different tasks by each group, or perform a particular task together. Different interaction patterns can be used at different stages of input of the user processing. Any conflict occurred in the topic, the flow of the conversation messages, or interaction pattern of the robots may result in the inability to proceed with the conversation.

In step S204, in response to the dimension(s) involved in the conversation massages among the multiple robots including a conflicting dimension, it is determined that there is a conflict in the conversation messages among the multiple robots.

After determining the presence of the conflict, the conflict type can be further determined. For example, the conflict type is determined for the conversation based on the types of conflicting dimensions. Conflict types can include topic conflicts, flow of the conversation messages conflicts, and robot interaction pattern conflicts, as well as further subdivisions of the above three conflict types. Of course, conflict types can also be divided according to other methods, which will not be described in detail here.

In the above embodiment, dimensions involved in the robot conversation can be extracted to determine whether there is a conflict in the conversation based on a dimension conflict. Therefore, it is possible to perform conflict detection more accurately.

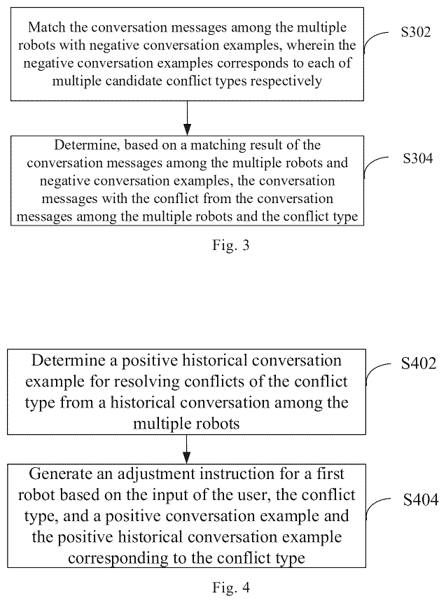

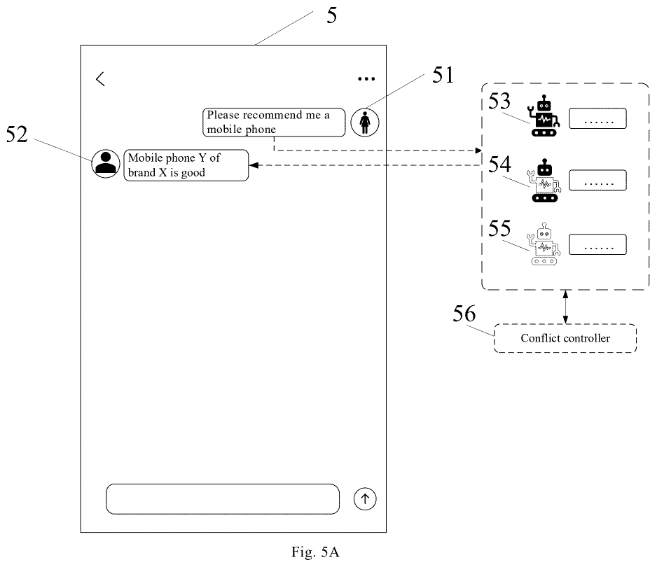

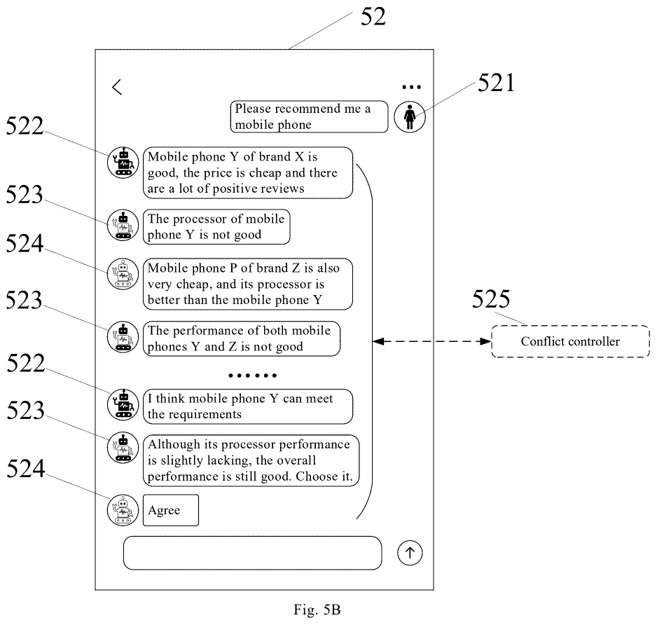

In addition to conflict detection based on the dimensions involved in the conversation, negative conversation examples for conflicts can also be determined in advance, so that conflict detection can be performed based on these negative conversation examples. A conflict detection method provided in another embodiment of the present disclosure will be described below with reference to FIG. 3.

FIG. 3 shows a flowchart of a conflict detection method according to other embodiments of the present disclosure. As shown in FIG. 3, the conflict detection method of this embodiment includes steps S302 to S304.

In step 302, the conversation messages among the multiple robots are matched with negative conversation examples, wherein the negative conversation examples corresponds to each of multiple candidate conflict types respectively.

The negative conversation examples refer to conversation examples with a conflict, which can be examples collected and set in other conversation scenarios before this robot conversation starts, or examples obtained by other means. The negative conversation examples can be conversation text or abstracted content based on negative conversation text. For example, the negative conversation examples may be “Robot T refuses to adjust its strategy even if it clearly conflicts with Robot U's goals” and “Robot T ignores the importance of sharing resources, resulting in low efficiency”.

In step S304, based on a matching result of the conversation messages among the multiple robots and negative conversation examples, the conversation messages with the conflict are determined from the conversation messages among the multiple robots and the conflict type is determined.

In the matching process, the robots'original conversational text can be matched with the negative conversation examples, which has a relatively high recognition accuracy; alternatively, semantic analysis and abstraction can be performed on the original conversation text of the robots to extract the main content of the conversation and match it with negative conversation examples. This approach can improve the accuracy of matching.

In some embodiments, a machine learning model can be used in the above process. For example, conversation messages among the robots and a prompt can be input into a conflict detection controller based on a machine learning model. The prompt may include an instruction for conflict detection in the conversation messages among the robots, as well as negative conversation examples. Therefore, the machine learning model can be used to process the conversation messages among the robots based on the prompt, which can efficiently and accurately detect conflicts and conflict types in the conversation messages by referring to the negative conversation examples and utilizing the powerful semantic understanding and analysis capabilities of the machine learning model.

In the above embodiment, conflict detection can be performed based on negative conversation examples, which can be used to accurately detect and analyze conflict information, and improve the efficiency of subsequent conflict resolution.

As mentioned earlier, when instructing a robot to make adjustments, all robots involved in the conversation messages with the conflict can be identified as the robots to be adjusted, or some robots involved in conversation messages with the conflict can be identified as the robots to be adjusted. When determining the robots to be adjusted, it is possible to further determine some robots as the robots to be adjusted from the robots involved in the conversation messages with the conflict based on the input of the user, the conflict type, and adjustment priorities of the multiple robots. Then, adjustment instructions can be sent to the robots to be adjusted.

Based on the input of the user, it can be determined which robot's setting information (such as the dimensions involved by the robot) is more relevant to the input of the user. That is, the robots to be adjusted can be determined based on the correlation between the setting information of the robots and the input of the user. For example, if the input of the user is “Recommend me a cheap and easy-to-use phone, preferably one that can be used for a long time”, although this input involves two dimensions of price and performance, the expression “preferably one that can be used for a long time” may reflect that the user places more emphasis on the performance dimension. In the event of a conflict, it is possible to instruct robots that make recommendations based on low prices to compromise and make concessions.

Based on its conflict type, it is possible to determine which robot is the source of the conflict. For example, the conflict between Robot A and Robot B is caused by Robot A not sharing information, and the conflict type is “information not shared”. This type of conflict is caused by a robot that does not share information. Therefore, Robot A, where the conflict originated, can be considered as the robot to be adjusted.

Based on the adjustment priorities of the multiple robots, it is possible to determine which robot should be prioritized for adjustment in the event of a conflict. The priority information can be preset or dynamically specified during robot interaction.

By using the above method to determine the robot to be adjusted, a feasible solution to the conflict can be provided more efficiently, thereby improving the efficiency of conflict resolution and increasing the efficiency of responding to the user.

In some embodiments, an adjustment instruction is generated based on the input of the user, the conflict type, and a positive conversation example corresponding to the conflict type. The positive conversation example refers to an example of a conflict that exist in conversations but are resolved during the course of the conversations. It can be an example collected and set in other conversation scenarios before this robot conversation starts, or an example obtained by other means. The positive conversation example can be the conversation text or abstracted content based on positive conversation text. By using the positive conversation example, the generated adjustment instruction can be more reasonable and feasible. An embodiment of a method for generating an adjustment instruction of this disclosure will be described below with reference to FIG. 4.

FIG. 4 shows a flowchart of a method for generating an adjustment instruction according to some embodiments of the present disclosure. As shown in FIG. 4, the method for generating an adjustment instruction in this embodiment includes steps S402 to S404.

In step S402, a positive historical conversation example for resolving conflicts of the conflict type is determined from a historical conversation among the multiple robots. That is, when the multiple robots are used to process the current task, solutions for similar conflicts can be provided as a reference for the current conflict. Since the positive historical conversation examples are generated by the current robots, it is possible to more effectively adjust the conflicting robots.

In step S404, an adjustment instruction for a first robot is generated based on the input of the user, the conflict type, and a positive conversation example and the positive historical conversation example corresponding to the conflict type, wherein the adjustment instruction comprises the positive historical conversation example.

The adjustment instruction is used to instruct the robot on how to adjust, which can be a specific adjustment strategy such as “make concessions on the price dimension”, “share known background information with other robots”, or can be a positive historical conversation example, a positive conversation example, or a combination of both.

The above embodiment improves the adjustment efficiency of the robot by using a positive historical conversation example as the basis for adjustment when instructing the robot to adjust, thus improving the response efficiency to the input of the user.

Several exemplary instruction generation methods will be described below for some conflict types, including a goal conflict, a strategy conflict, an information understanding conflict, and a resource allocation conflict.

In some embodiments, the conflict type includes a goal inconsistency conflict. Generating an adjustment instruction includes: determining, based on the input of the user, the conflict type, an example corresponding to the conflict type, and goals of a first robot and a second robot involved in the conflict, goal adjustment information of the first robot; and generating the adjustment instruction for the first robot based on the adjustment information. Each of the first robot and the second robot can be one or more robots.

The goal of a robot can be understood as being determined by the robot based on the input of the user and the robot's setting information. For example, if the input of the user is “recommend me a mobile phone” and the robot is inclined to recommend cheap phones, then the initial goal of the robot is “recommend the user a mobile phone with a price not exceeding xx”. As the conversation progresses, there may be slight adjustment to this goal.

The goal adjustment information may include at least one of an adjustment direction or an adjustment amplitude, to instruct the first robot to compromise and partially achieve its original goal. Alternatively, it may include an adjusted goal to instruct the first robot to redetermine its goal.

This embodiment provides an adjustment instruction that includes goal adjustment information to instruct the robot to directly solve the problem that arises when balancing different goals. By analyzing the conflict among adversarial digital humans and proposing a specific solution, it is possible to reduce conflicts among robots and improve the efficiency of responding to users.

In some embodiments, the conflict type includes a strategy inconsistency conflict. Generating an adjustment instruction includes: generating a new strategy based on an original strategy of the multiple robot with respect to the input of the user, the conflict type, and an example corresponding to the conflict type; and generating the adjustment instruction based on the new strategy. The strategy refers to an operational strategy adopted by a robot in response to the input of the user, and the actions taken based on the operational strategy are reflected in the flow of conversation. For example, the strategy may be a series of steps to take in response to a user, or information to obtain or generate in different situations, and so on.

When a conflict arises in the strategies of robots, generating a new strategy and instructing a robot to adopt the new strategy can harmonize the strategies of the robots, thereby reducing conflicts among the robots and improving the efficiency of responding to the user.

In some embodiments, the conflict type includes an information understanding conflict. Generating an adjustment instruction includes: determining background information involved in the conversation messages with the conflict; and generating, based on the input of the user, the conflict type, and an example corresponding to the conflict type, an instruction to provide the background information or an instruction to accept the background information as the adjustment instruction. The information understanding conflict includes differences or misunderstandings in information comprehension. Since different robots have different setting information, different robots may rely on different sources of information or background knowledge when generating messages. The adjustment instruction can instruct the robots to integrate their respective information in order to eliminate information understanding conflicts. By the instruction to provide background information, a robot is enabled to actively send information that the other parties do not have; and by the instruction to receive background information, a robot is enabled to incorporate the information provided by the other parties as part of its own information.

By promoting knowledge fusion, different robots can be instructed to integrate their information and perspectives, thereby facilitating more comprehensive decision making for each robot and improving the reliability and usability of the response to the user.

In some embodiments, the conflict type includes a resource allocation conflict. Generating an adjustment instruction includes: generating setting information details for the multiple robots based on the input of the user, the conflict type, and an example corresponding to the conflict type; generating a resource sharing strategy based on the setting information details for the multiple robots; and generating the adjustment instruction based on the setting information details for the multiple robots and the resource sharing strategy.

Resource conflicts and robot setting information are often interrelated. For example, in resource allocation scenarios, different roles may have conflicts due to different resource requirements. Differences in setting information may also affect the allocation and use of resources. When generating a resource sharing strategy and an adjustment instruction, by referring to the setting information of the robots, the robot conversation conflict can be resolved more comprehensively.

Therefore, by generating robot setting information details based on the conflict type, it is possible to further refine the original setting information of the robots to help clarify and optimize the roles and responsibilities of different robots. On this basis, by generating resource sharing strategies, it is possible to balance the fairness and effectiveness of resource allocation to achieve an overall improvement in the response generation efficiency of the robots.

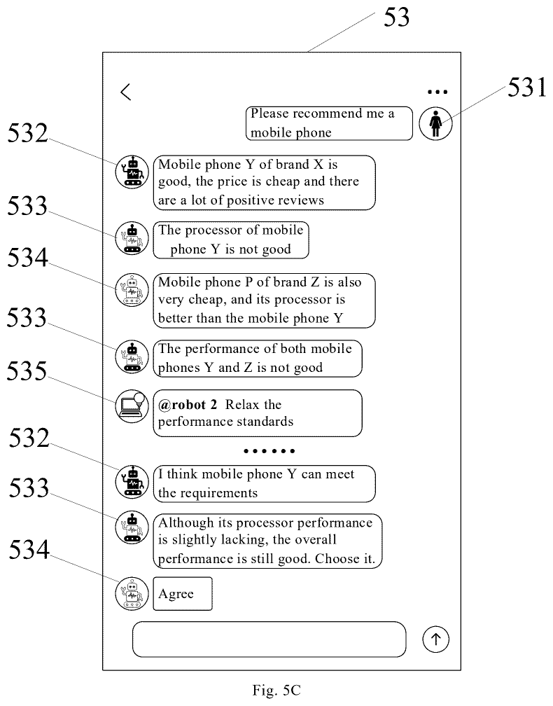

In some embodiments of the present disclosure, the conversation process among the multiple robots may be invisible or visible to the user. The adjustment instructions for the robots can be either invisible or visible to the user. The following description will be given with reference to FIGS. 5A to 5C.

FIG. 5A shows a schematic diagram of a user interface according to some embodiments of the present disclosure. As shown in FIG. 5A, an interface 51 includes a conversation between a user 511 and an intelligent virtual object 512. The user enters “Please recommend me a mobile phone”. After receiving the input of the user, the backend (which can be a terminal or server) of the application where the interface 51 is located calls multiple adversarial robots 513, 514, 515 for a “conversation” invisible to the user. During the “conversation”, a conflict controller 516 located in the backend performs conflict detection and sends adjustment instructions to the robots when a conflict is detected. After reaching an agreement among the robots 53, 54, and 55, feedback is given to the user via the intelligent virtual object 52 on the front-end, stating that “Model Y of brand X is good”. This method can provide feedback directly to the user, thereby improving the efficiency of receiving effective information.

FIG. 5B shows a schematic diagram of a user interface according to other embodiments of the present disclosure. As shown in FIG. 5B, an interface 52 includes a conversation among a user 521 and multiple robots 523, 524, 525, and the conversation messages among the robots are visible to the user. Meanwhile, a conflict controller 525 located in the background monitors the conversation content among the robots and performs conflict detection. According to the detection results, the conflict controller 525 determined that the robot 523 was too persistent in its requirements for mobile phone performance and did not compromise on the recommendations of other robots, resulting in a deadlock in the conversation. The conflict controller 525 can send an adjustment instruction to the robot 523 to relax its performance requirements. After a few rounds of conversation and discussion, robots 523, 524, and 525 reach a unanimous decision to recommend X brand model Y, thus providing a conflict-free response to the input of the user. This approach presents the discussion process among the robots to the user, making it easier for the user to obtain more relevant information.

FIG. 5C shows a schematic diagram of a user interface according to still other embodiments of the present disclosure. As shown in FIG. 5C, an interface 53 includes a conversation among a user 531 and multiple robots 533 (Robot 1), 534 (Robot 2), and 535 (Robot 3), and the conversation messages among the robots are visible to the user. In addition, the conflict controller 535 also serves as a member of the group chat and sends adjustment instruction by posting messages in the group chat when a conflict is detected. According to the detection results, the conflict controller 535 determined that the robot 533 was too persistent in its requirements for mobile phone performance and did not compromise on the recommendations of the other robots, resulting in a deadlock in the conversation. The conflict controller 535 can send a “relax the performance standards” instruction to robot 2 in the group chat to guide the conversation to proceed smoothly until the three robots reach a consensus. This approach presents the discussion and adjustment process among the robots to the user, which can make it easier for the user to obtain more relevant information and make the recommendation logic of each robot clearer to the user, thus providing further reference for the final decision.

The control method of robot according to some embodiments of the present disclosure has been described above. Below, embodiments of a related apparatus of the present disclosure will be described in conjunction with other accompanying drawings.

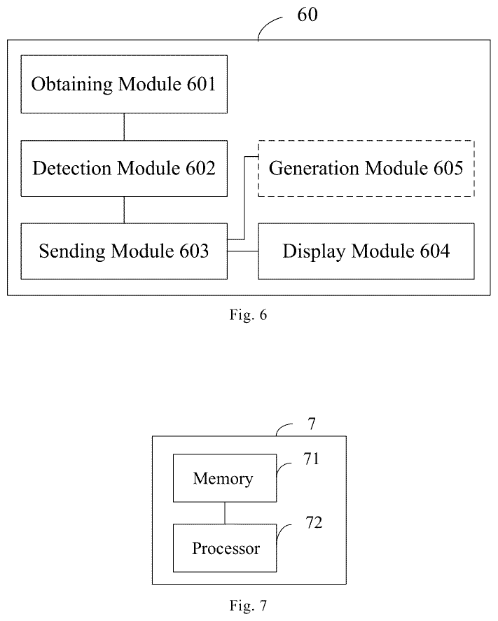

FIG. 6 shows a schematic structural diagram of a control apparatus of robot according to some embodiments of the present disclosure. As shown in FIG. 6, the control apparatus of robot 60 of this embodiment includes: an obtaining module 601 configured for obtaining, in response to an input of a user, conversation messages among multiple robots with respect to the input of the user, wherein the multiple robots have an adversarial relationship to each other; a detection module 602 configured for performing conflict detection on the conversation messages among the multiple robots to determine conversation messages with a conflict and a conflict type; a sending module 603 configured for sending an adjustment instruction to at least one robot involved in the conflict, to enable each adjusted robot to continuously converse with other robots based on the adjustment instruction, wherein the adjustment instruction is generated based on the input of the user and the conflict type; and a display module 604 configured for displaying, in response to the conversation messages among the multiple robots comprising a response to the input of the user without a conflict, the response.

In some embodiments, the input of the user involves multiple dimensions, and each of the multiple robots is configured to generate conversation messages based on some or all of the multiple dimensions.

In some embodiments, the detection module 602 is further configured for determining dimensions involved in the conversation messages between multiple robots; in response to the presence of conflicting dimensions among the dimensions involved in the conversation messages among the multiple robots, it is determined that there is a conflict in the conversation of the multiple robots.

In some embodiments, the detection module 602 is further configured for: determining dimension(s) involved in the conversation massages among the multiple robots; and determining, in response to the dimension(s) involved in the conversation massages among the multiple robots comprising a conflicting dimension, that there is a conflict in the conversation messages among the multiple robots.

In some embodiments, the detection module 602 is further configured for: determining, based on the conversation messages among the multiple robots, at least one of a topic of the conversation messages, a flow of the conversation messages, or an interaction pattern of the multiple robots; and determining dimensions involved in at least one of the topic of the conversation messages, the flow of the conversation messages or the interaction pattern of the multiple robots as the dimension(s) involved in the conversation messages among the multiple robots

In some embodiments, the sending module 603 is further configured for: determining all robots involved in the conversation messages with the conflict as robots to be adjusted, or determining a part of the robots involved in the conversation messages with the conflict as robot(s) to be adjusted based on the input of the user, the conflict type, and adjustment priorities of the multiple robots; and sending the adjustment instruction to the robot(s) to be adjusted In some embodiments, the control apparatus of robot 60 further includes a generation module 605, which is configured to generate an adjustment instruction.

In some embodiments, the generation module 605 is further configured for generating the adjustment instruction based on the input of the user, the conflict type, and a positive conversation example corresponding to the conflict type.

In some embodiments, the generation module 605 is further configured for: determining a positive historical conversation example for resolving conflicts of the conflict type from a historical conversation among the multiple robots; and generating an adjustment instruction for a first robot based on the input of the user, the conflict type, and a positive conversation example and the positive historical conversation example corresponding to the conflict type, wherein the adjustment instruction comprises the positive historical conversation example.

In some embodiments, the conflict type comprises a goal inconsistency conflict, and the generation module 605 is further configured for: determining, based on the input of the user, the conflict type, an example corresponding to the conflict type, and goals of a first robot and a second robot involved in the conflict, goal adjustment information of the first robot; and generating the adjustment instruction for the first robot based on the adjustment information.

In some embodiments, the conflict type comprises a strategy inconsistency conflict, and the generation module 605 is further configured for generating a new strategy based on an original strategy of the multiple robot with respect to the input of the user, the conflict type, and an example corresponding to the conflict type; and generating the adjustment instruction based on the new strategy.

In some embodiments, the conflict type comprises an information understanding conflict, and the generation module 605 is further configured for: determining background information involved in the conversation messages with the conflict; and generating, based on the input of the user, the conflict type, and an example corresponding to the conflict type, an instruction to provide the background information or an instruction to accept the background information as the adjustment instruction.

In some embodiments, the conflict type comprises a resource allocation conflict, and the generation module 605 is further configured for: generating setting information details for the multiple robots based on the input of the user, the conflict type, and an example corresponding to the conflict type; generating a resource sharing strategy based on the setting information details for the multiple robots; and generating the adjustment instruction based on the setting information details for the multiple robots and the resource sharing strategy.

In some embodiments, the adjustment instruction also includes conversation messages with the conflict.

It should be noted that the above units are only logical modules divided according to their specific functions and are not intended to limit the specific ways in which they are implemented. For example, they may be implemented in software, hardware or a combination of software and hardware. In practical implementation, the above units may be implemented as independent physical entities, or they can also be implemented by a single entity (such as a processor (CPU or DSP), integrated circuit, etc.). In addition, the above units are indicated by dashed lines in the accompanying drawings, indicating that these units may not actually exist and that the operations/functions they perform may be performed by a processing circuit per se.

In addition, although not shown, the device may also include a memory that can store various information generated by the device or various units in the device during operation, programs and data used for operation, data to be sent by a communication unit, and so on. The memory may be volatile memory and/or non-volatile memory. For example, the memory may include, but is not limited to, random access memory (RAM), dynamic random access memory (DRAM), static random access memory (SRAM), read-only memory (ROM), and flash memory. Of course, the memory may also be located outside of the device. Optionally, although not shown, the device may also include a communication unit that may be used to communicate with other apparatus. In an example, the communication unit may be implemented in any suitable manner known in the art, including communication components such as an antenna array and/or radio frequency links, various types of interfaces, communication units, and so on, which will not be described in detail herein. In addition, the device may also include other components not shown, such as a RF link, a baseband processing unit, a network interface, a processor, a controller, etc., which will not be described in detail herein.

Some embodiments of the present disclosure further provide an electronic device. FIG. 7 shows a schematic structural diagram of an electronic device according to some embodiments of the present disclosure; For example, in some embodiments, the electronic device 7 may be any type of electronic device, such as, but not limited to, a mobile terminal such as a mobile phone, a laptop, a digital broadcast receiver, a PDA (personal digital assistant), a PAD (tablet computer), a PMP (portable multimedia player), a vehicle terminal (such as vehicle navigation terminal), or a fixed terminal such as a digital TV, a desktop computer, etc. For example, the electronic device 7 may include a display panel for displaying data and/or execution results utilized in the scheme of the present disclosure. For example, the display panel can have various shapes. For example, it can be a rectangular panel, an elliptical panel, or a polygonal panel. Furthermore, the display can be not only flat, but curved or even spherical.

As shown in FIG. 7, the electronic device 7 of this embodiment comprises: a memory 71 and a processor 72 coupled to the memory 71. It should be noted that the components of the electronic device 7 shown in FIG. 7 are illustrative and not limiting. Depending on the actual application requirements, the electronic device 7 may include other components. The processor 72 can control other components in the electronic device 7 to perform desired functions.

In some embodiments, the memory 71 is used to store one or more computer-readable instructions. The processor 72 is used to execute these computer-readable instructions that, when executed by the processor 72, perform the method according to any of the above embodiments. The specific implementation of each step of the method and related explanations can be found in the above embodiments, and will not be repeated here.

For example, the processor 72 and the memory 71 can directly or indirectly communicate with each other. For example, the processor 72 and the memory 71 can communicate over a network. The network can be a wireless network, a wired network, and/or any combination of wireless and wired networks. The processor 72 and the memory 71 may also communicate with each other over a system bus, and this disclosure is not limited thereto.

For example, the processor 72 may be embodied as various suitable processors, processing devices, etc., such as a central processing unit (CPU), a graphics processing unit (GPU), a network processor (NP), etc; It can also be a digital signal processor (DSP), an application specific integrated circuit (ASIC), a field programmable gate array (FPGA), or other programmable logic devices, discrete gates or transistor logic devices, or discrete hardware components. The central processing unit (CPU) may be based on the X86 or ARM architecture. For example, the memory 71 may include any combination of various forms of computer-readable storage media, such as volatile memory and/or non-volatile memory. The memory 71 may include a system memory, which stores an operating system, application programs, a boot loader, a database, and other programs. Various applications and data can also be stored in the storage media.

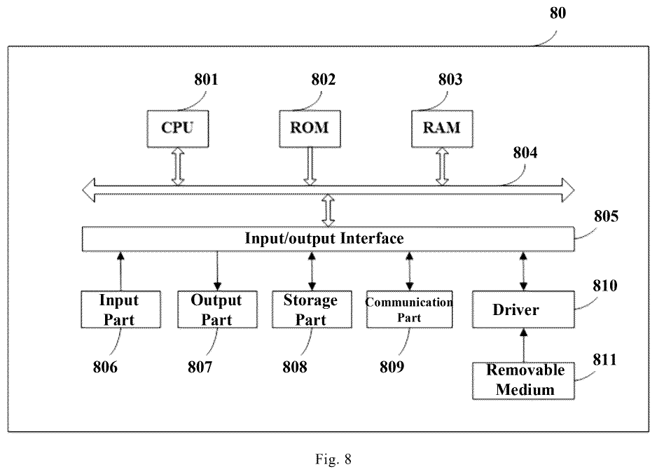

In addition, according to some embodiments of the present disclosure, various operations/processes according to the present disclosure may be implemented by software and/or firmware, and programs constituting the software may be installed, from storage media or networks, on a computer system having dedicated hardware structures, such as the computer system 80 shown in FIG. 8. The computer system with various programs installed can perform various functions, including those functions mentioned above. FIG. 8 shows a schematic structural diagram of a computer system according to some embodiments of the present disclosure.

In FIG. 8, the central processing unit (CPU) 801 performs various processes based on programs stored in the read-only memory (ROM) 802 or programs loaded from the storage device 808 to the random access memory (RAM) 803. Data required for CPU 801 to perform various processes is also stored in RAM 803 as needed. The central processing unit is only an example and can also be other types of processors, such as the various processors mentioned above. The ROM 802, RAM 803, and storage section 808 may be various forms of computer readable storage media, as described below. It should be noted that although ROM 802, RAM 803, and storage device 808 are shown separately in FIG. 8, one or more of them may be combined or located in the same or different memory or storage modules.

The CPU 801, the ROM 802, and the RAM 803 are connected to each other via a bus 804. An input/output (I/O) interface 805 is also connected to the bus 804.

The following components are connected to the input/output interface 805: an input section 806, such as a touch screen, a touch pad, a keyboard, a mouse, an image sensor, a microphone, an accelerometer, a gyroscope, etc; an output section 807, including a display such as a cathode ray tube (CRT), liquid crystal display (LCD), a speaker, a vibrator, etc; a storage section 808, including a hard disk drive, a magnetic tape drive, etc; and a communication section 809 including a network interface card such as a LAN card, a modem, etc. The communication section 809 allows communication to be performed over a network such as the Internet. It is easy to understand that although the various devices or modules in the computer system 80 are shown in FIG. 8 communicating over the bus 804, they may also communicate over networks or other means, where the networks may include wireless networks, wired networks, and/or any combination of wireless and wired networks.

A drive 810 is also connected to input/output interface 805 as needed. A removable medium 811, such as a magnetic disk, an optical disk, a magneto-optical disk, a semiconductor memory, etc., is mounted on the drive 810 as needed so that computer programs read from the medium can be installed in the storage section 808 as needed.

In the case of implementing the above series of processes by software, the programs that make up the software may be installed from a network, such as the Internet, or from a storage medium, such as the removable media 811.

According to an embodiment of the present disclosure, the processes described above with reference to the flowchart can be implemented as a computer software program. For example, some embodiments of the present disclosure include a computer program product comprising a computer program carried on a computer-readable medium, the computer program containing program code for performing the method illustrated in the flowcharts. In such an embodiment, the computer program may be downloaded and installed from the network through the communication device 809, or installed from the storage device 808, or from the ROM 802. When the computer program is executed by a CPU 801, the above functions defined in the method provided by the embodiment of the present disclosure are performed.

It should be noted that, in the context of the present disclosure, a computer-readable medium may be a tangible medium, which may contain or store a program for use by or in connection with an instruction execution system, apparatus, or device. The computer readable medium may be a computer readable signal medium or a computer readable storage medium, or any combination of thereof. The computer readable storage medium may be, but is not limited to: an electronic, magnetic, optical, electromagnetic, infrared, or semiconductor system, apparatus, or device, or any combination of the above. More specific examples of the computer readable storage medium may include, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may include a data signal that is propagated in the baseband or as part of a carrier, carrying computer readable program code. Such propagated data signals can take a variety of forms including, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, including but not limited to wire, fiber optic cable, RF (radio frequency), etc., or any suitable combination of the foregoing.

The above computer readable medium may be included in the electronic device described above; or it may exist alone without being assembled into the electronic device.

In some embodiments, there is further provided a computer program, comprising: instructions that, when executed by a processor, cause the processor to perform the method of any one of the above embodiments. For example, the instructions can be embodied as computer program code.

In embodiments of the present disclosure, computer program code for executing operations of the present disclosure may be complied by any combination of one or more program design languages, the program design languages including, but not limited to, object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area networks (LAN) or wide area networks (WAN), or connected to external computers (for example using an Internet service provider via the Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules, components or units involved in the embodiments described in the present disclosure can be implemented by software or hardware. Wherein, the names of the modules, components or units do not constitute a limitation on the modules, components or units themselves under certain circumstances.

The functions described above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD), etc.

The above description only shows some embodiments of the present disclosure and illustrates technical principles applied in the present disclosure. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

Many specific details are elaborated in the description of the present disclosure. However, it is understood that embodiments of the present invention can be implemented without these specific details. In other cases, well-known methods, structures, and techniques are not described in detail so as not to obscure the understanding of the description.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. A control method of robot, comprising:
obtaining, in response to an input of a user, conversation messages among multiple robots with respect to the input of the user, wherein the multiple robots have an adversarial relationship to each other;
performing conflict detection on the conversation messages among the multiple robots to determine conversation messages with a conflict and a conflict type;
sending an adjustment instruction to at least one robot involved in the conflict, to enable each adjusted robot to continuously converse with other robots based on the adjustment instruction, wherein the adjustment instruction is generated based on the input of the user and the conflict type; and
displaying, in response to the conversation messages among the multiple robots comprising a response to the input of the user without a conflict, the response.

2. The control method according to claim 1, wherein the input of the user involves multiple dimensions, and each of the multiple robots is configured to generate conversation messages based on some or all of the multiple dimensions.

3. The conversation method according to claim 1, wherein the performing the conflict detection on the conversation messages among the multiple robots comprises:
determining dimension(s) involved in the conversation massages among the multiple robots; and
determining, in response to the dimension(s) involved in the conversation massages among the multiple robots comprising a conflicting dimension, that there is a conflict in the conversation messages among the multiple robots.

4. The control method according to claim 3, wherein the performing conflict detection on the conversation messages among the multiple robots comprises:
determining, based on the conversation messages among the multiple robots, at least one of a topic of the conversation messages, a flow of the conversation messages, or an interaction pattern of the multiple robots; and
determining dimensions involved in at least one of the topic of the conversation messages, the flow of the conversation messages or the interaction pattern of the multiple robots as the dimension(s) involved in the conversation messages among the multiple robots.

5. The control method according to claim 1, wherein the performing the conflict detection on the conversation messages among the multiple robots to determine the conversation messages with the conflict and the conflict type comprises:
determining, based on a matching result of the conversation messages among the multiple robots and negative conversation examples, the conversation messages with the conflict from the conversation messages among the multiple robots and the conflict type, wherein the negative conversation examples corresponds to each of multiple candidate conflict types respectively.

6. The control method according to claim 1, wherein the sending the adjustment instruction to the at least one robot involved in the conversation messages with the conflict comprises:
determining all robots involved in the conversation messages with the conflict as robots to be adjusted, or determining a part of the robots involved in the conversation messages with the conflict as robot(s) to be adjusted based on the input of the user, the conflict type, and adjustment priorities of the multiple robots; and
sending the adjustment instruction to the robot(s) to be adjusted.

7. The control method according to claim 1, further comprising:
generating the adjustment instruction based on the input of the user, the conflict type, and a positive conversation example corresponding to the conflict type.

8. The control method according to claim 7, wherein the generating the adjustment instruction comprises:
determining a positive historical conversation example for resolving conflicts of the conflict type from a historical conversation among the multiple robots; and
generating an adjustment instruction for a first robot based on the input of the user, the conflict type, and a positive conversation example and the positive historical conversation example corresponding to the conflict type, wherein the adjustment instruction comprises the positive historical conversation example.

9. The control method according to claim 1, wherein the conflict type comprises a goal inconsistency conflict, and the control method further comprises:
determining, based on the input of the user, the conflict type, an example corresponding to the conflict type, and goals of a first robot and a second robot involved in the conflict, goal adjustment information of the first robot; and
generating the adjustment instruction for the first robot based on the adjustment information.

10. The control method according to claim 1, wherein the conflict type comprises a strategy inconsistency conflict, and the control method further comprises:
generating a new strategy based on an original strategy of the multiple robot with respect to the input of the user, the conflict type, and an example corresponding to the conflict type; and
generating the adjustment instruction based on the new strategy.

11. The control method according to claim 1, wherein the conflict type comprises an information understanding conflict, and the control method further comprises:
determining background information involved in the conversation messages with the conflict; and
generating, based on the input of the user, the conflict type, and an example corresponding to the conflict type, an instruction to provide the background information or an instruction to accept the background information as the adjustment instruction.

12. The control method according to claim 1, wherein the conflict type comprises a resource allocation conflict, and the control method further comprises:
generating setting information details for the multiple robots based on the input of the user, the conflict type, and an example corresponding to the conflict type;
generating a resource sharing strategy based on the setting information details for the multiple robots; and
generating the adjustment instruction based on the setting information details for the multiple robots and the resource sharing strategy.

13. The control method according to claim 1, wherein the adjustment instruction further comprises the conversation messages with the conflict.

14. A control apparatus of robot, comprising:
at least one memory; and
at least one processor coupled to the memory, the processor configured to, based on instructions stored in the memory, implement a control method of robot comprising:
obtaining, in response to an input of a user, conversation messages among multiple robots with respect to the input of the user, wherein the multiple robots have an adversarial relationship to each other;
performing conflict detection on the conversation messages among the multiple robots to determine conversation messages with a conflict and a conflict type;
sending an adjustment instruction to at least one robot involved in the conflict, to enable each adjusted robot to continuously converse with other robots based on the adjustment instruction, wherein the adjustment instruction is generated based on the input of the user and the conflict type; and
displaying, in response to the conversation messages among the multiple robots comprising a response to the input of the user without a conflict, the response.

15. A non-transitory computer-readable storage medium stored thereon a computer program that, when executed by a processor, implements a control method of robot according comprising
obtaining, in response to an input of a user, conversation messages among multiple robots with respect to the input of the user, wherein the multiple robots have an adversarial relationship to each other;
performing conflict detection on the conversation messages among the multiple robots to determine conversation messages with a conflict and a conflict type;
sending an adjustment instruction to at least one robot involved in the conflict, to enable each adjusted robot to continuously converse with other robots based on the adjustment instruction, wherein the adjustment instruction is generated based on the input of the user and the conflict type; and
displaying, in response to the conversation messages among the multiple robots comprising a response to the input of the user without a conflict, the response.

16-17. (canceled)

18. The electronic device according to claim 14, wherein the input of the user involves multiple dimensions, and each of the multiple robots is configured to generate conversation messages based on some or all of the multiple dimensions.

19. The electronic device according to claim 14, wherein the performing the conflict detection on the conversation messages among the multiple robots comprises:
determining dimension(s) involved in the conversation massages among the multiple robots; and
determining, in response to the dimension(s) involved in the conversation massages among the multiple robots comprising a conflicting dimension, that there is a conflict in the conversation messages among the multiple robots.

20. The electronic device according to claim 19, wherein the performing conflict detection on the conversation messages among the multiple robots comprises:
determining, based on the conversation messages among the multiple robots, at least one of a topic of the conversation messages, a flow of the conversation messages, or an interaction pattern of the multiple robots;
determining dimensions involved in at least one of the topic of the conversation messages, the flow of the conversation messages or the interaction pattern of the multiple robots as the dimension(s) involved in the conversation messages among the multiple robots.

21. The electronic device according to claim 14, wherein the performing the conflict detection on the conversation messages among the multiple robots to determine the conversation messages with the conflict and the conflict type comprises:
determining, based on a matching result of the conversation messages among the multiple robots and negative conversation examples, the conversation messages with the conflict from the conversation messages among the multiple robots and the conflict type, wherein the negative conversation examples corresponds to each of multiple candidate conflict types respectively.

22. The electronic device according to claim 14, wherein the sending the adjustment instruction to the at least one robot involved in the conversation messages with the conflict comprises:
determining all robots involved in the conversation messages with the conflict as robots to be adjusted, or determining a part of the robots involved in the conversation messages with the conflict as robot(s) to be adjusted based on the input of the user, the conflict type, and adjustment priorities of the multiple robots; and
sending the adjustment instruction to the robot(s) to be adjusted.
